(19) United States
(12) Patent Application Publication
(10) Pub. No.: US 2008/0319630 A1
(43) Pub. Date: Dec. 25, 2008

(54) Adaptive air intake manifold valve actuator (IMVA)

(76) Inventors: Esau Aguinaga, Cd. Juarez (MX); Mario A. Recio, Cd. Juarez (MX)

Correspondence Address: DELPHI TECHNOLOGIES, INC., M/C 480-410-202, PO BOX 5052, TROY, MI, 48007, US

(21) Appl. No.: 11/821,247

(22) Filed: Jun. 22, 2007

(51) Int. Cl. F02D 28/00

(52) U.S. Cl. 701/101

(57) ABSTRACT

The rate of motion of a vehicle air intake valve is measured and used to control the algorithm that controls the valve, such that the control algorithm adapts to the actual conditions in the vehicle as reflected in the actual rate of motion of the valve.

### I. FIELD OF THE INVENTION

The present invention relates generally to controllers for controlling valves in vehicle intake manifolds.

### II. BACKGROUND OF THE INVENTION

An internal combustion engine, powered by either diesel fuel or gasoline, includes generally an intake manifold assembly for collecting air from outside the engine and distributing the collected air to each of the combustion cylinders. In modern engines, the manifold typically is part of a relatively complex assembly known generally in the art as an integrated air/fuel module (IAFM). The IAFM may include a variety of sub-systems for performing a host of related functions, including, for example, a throttle body and valve for air flow control, a helmholz resonator for noise suppression, an exhaust gas recirculation valve for mixing exhaust gas into the fresh air stream, a fuel rail and fuel injectors for injecting fuel to the cylinders, and a purge valve for stripping fuel from a fuel tank canister. The present invention non-exclusively is directed to optimally controlling the position of an air intake valve in this system.

As understood herein, the electric actuators and associated air intake valves help reduce emissions at cold start, increase fuel economy, and increase power by creating turbulence and/or changing the path the air mixture follows to the cylinder. As also understood herein, however, unknown variables such as temperature, load, supplied voltage, degree of valve wear, etc. can arise that may differ from the design values assumed by the control algorithm. When this occurs valve response time can be affected, potentially reducing the efficacy of the system.

The present invention recognizes that it would be advantageous to account for departures from nominal variable values without having to provide a plethora of sensors in the manifold to somehow directly measure temperature, load, supplied voltage, degree of valve wear, etc.

### SUMMARY OF THE INVENTION

A control component such as a valve controller in an engine and/or an associated engine control module (ECM) is disclosed for controlling an air intake valve of an engine. The control component receives a rate of movement of the valve, and based on the rate, selectively alters a control parameter that is associated with the control component.

In one embodiment, the control parameter is an output voltage to the valve. The output voltage may be established by selecting one of plural valve control algorithms to be executed by the control component, with the algorithms differing from each other only in the respective output voltages generated for the same set of input parameters.

In other embodiments, the control parameter can be a valve position sampling period of the component. In still other embodiments, the control parameter can be a target valve position input to a control algorithm of the control component.

Combinations of these embodiments may be used, and more than one control parameter may be established in response to the slew rate.

In another aspect, a method for controlling a valve includes comparing an actual valve speed with an expected valve speed, and based thereon selectively altering a control parameter of the valve.

In still another aspect, a system for controlling an intake valve of a vehicle manifold includes means for receiving a slew rate associated with the valve, and means for altering a control parameter associated with movement of the valve in response to the means for receiving.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 shows a system in accordance with one non-limiting embodiment of the present invention; and

FIG. 2 is a flow chart of logic in accordance with present principles.

### DETAILED DESCRIPTION OF THE PREFERRED EMBODIMENT

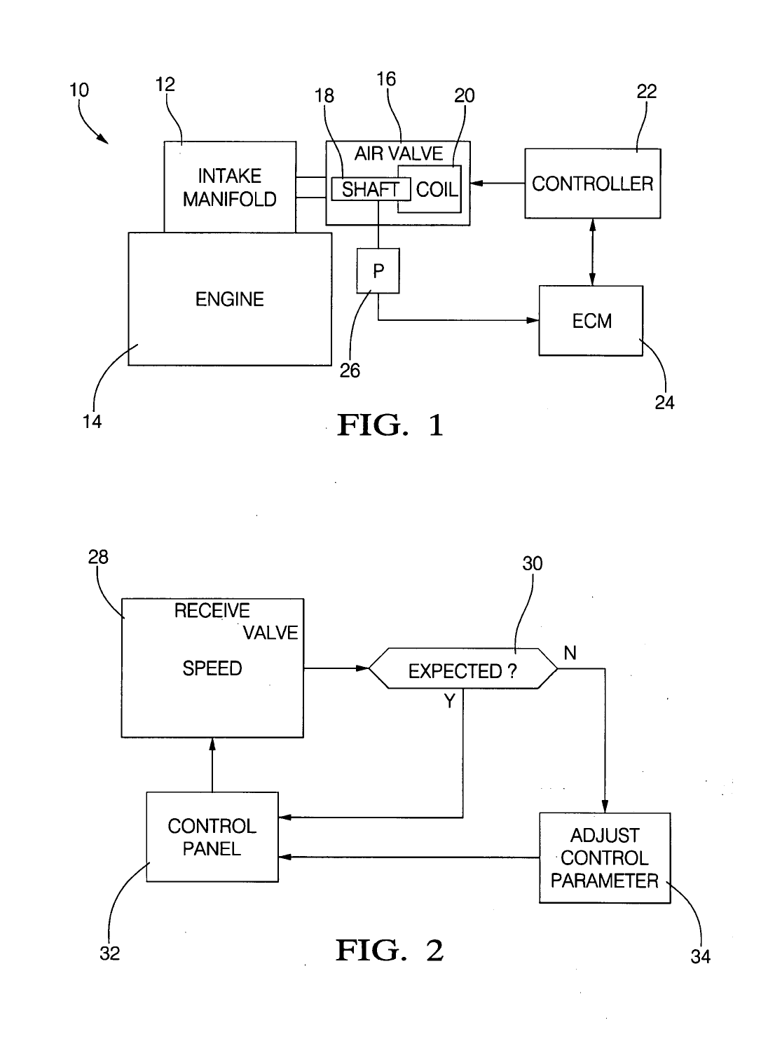

Referring initially to FIG. 1, a system is shown, generally designated 10, for controlling fluid flow through an intake manifold 12 of a vehicle engine 14. As shown, an air intake valve 16 with a moving part such as a shaft 18 and motor coil 20 for moving the shaft 18 ports air and/or fuel into the manifold 12. The coil 20 may be selectively energized as desired by a manifold controller 22 to move the shaft 18, and/or the controller 22 may communicate with an engine control module (ECM) 24 to control the intake manifold 12. The logic of FIG. 2 may be executed by the controller 22 and/or by the ECM 24 in response to signals received from a sensor 26 that may output a signal representing the position of the valve 16 (in which case the controller 22/ECM 24 can determine the speed of the shaft) and/or the speed of the valve 16 (in which case the speed need not be determined by the controller 22/ECM 24.)

FIG. 2 shows that the present logic commences at block 28 by receiving the speed of the valve 16, e.g., the speed of the movement of the shaft 18. The speed can be received directly from the sensor 26 or it can be calculated by dividing successive position signals by the time interval between them, or by other appropriate means. The valve speed may be thought of as the slew rate of the valve. The speed may be obtained after the valve moves, e.g., twenty percent (20%) of a total ideal distance of travel.

At decision diamond 30 it is determined whether the speed is within an acceptable range of the expected speed. The acceptable range may be close to or equal to zero, i.e., a “yes” answer is returned only if the measured speed substantially equals the expected speed. The expected speed may be for design values of temperature, valve wear, supplied voltage, load, etc.

When the measured speed is within the acceptable range of the expected speed, the logic flows to block 32 without change to the control algorithm or its inputs to control the position of the valve. However, when the measured speed is not within an acceptable range of the expected speed, the logic moves to block 34 to adjust one or more control parameters, and then controls the valve position at block 32 using the adjusted parameter(s).

In one implementation, the control parameter is an output voltage from the controller 32/ECM 34 to the coil 20 of the valve 16, sometimes referred to as the “PID” value. In some implementations plural valve control algorithms can be provided, with the algorithms differing from each other only in the respective output voltages (PIDs) generated for the same set of input parameters, and at block 34 in this implementation a stricter control algorithm (if the valve moves too slowly) or more relaxed control algorithm (if the valve moves too fast) than the one currently in use can be selected at block 34. A stricter algorithm outputs a higher PID than a more relaxed algorithm for the same set of input parameters.

Alternatively, only a single control algorithm need be used. In this case, the control parameter can be a valve position sampling period of the component. A faster sampling rate may result in the control algorithm moving the valve faster, so if the valve is measured to move too slowly, the rate at which the signal from the sensor 16 is sampled can be increased at block 34, and vice-versa.

Yet again, only a single control algorithm need be used, and the control parameter can be a target valve position that is input to a control algorithm. Thus, for instance, if the valve is measured to move too slowly, the target valve position can be lengthened further from the current actual valve position than it otherwise would be, and if the valve moves too quickly, the input target valve position can be modified to be less distant from the current actual valve position than it would otherwise be.

While the particular ADAPTIVE AIR INTAKE MANIFOLD VALVE ACTUATOR (IMVA) is herein shown and described in detail, it is to be understood that the subject matter which is encompassed by the present invention is limited only by the claims.

What is claimed is:

1. A control component for controlling an air intake valve of an engine and executing comprising:
receiving a rate of movement of the valve; and
based on the rate, selectively altering at least one control parameter associated with the control component.

2. The component of claim 1, wherein the control parameter is an output voltage to the valve.

3. The component of claim 2, wherein the output voltage is established by selecting one of plural valve control algorithms to be executed by the component, the algorithms differing from each other only in the respective output voltages generated for the same set of input parameters.

4. The component of claim 1, wherein the control parameter is a valve position sampling period of the component.

5. The component of claim 1, wherein the control parameter is a target valve position input to a control algorithm of the component.

6. The component of claim 1, wherein the component is a valve controller in an engine having an engine control module (ECM).

7. The component of claim 1, wherein the component is an engine control module (ECM) in an engine having an air intake valve controller.

8. A method for controlling a valve, comprising:
comparing an actual valve speed with an expected valve speed; and
based at least in part on the comparing act, selectively altering a control parameter of the valve.

9. The method of claim 8, wherein the valve is an air intake valve for an intake manifold of a vehicle.

10. The method of claim 9, wherein the control parameter is an output voltage to the valve.

11. The method of claim 10, wherein the output voltage is established by selecting one of plural valve control algorithms, the algorithms differing from each other only in the respective output voltages generated for the same set of input parameters.

12. The method of claim 9, wherein the control parameter is a valve position sampling period.

13. The method of claim 9, wherein the control parameter is a target valve position input to a control algorithm.

14. The method of claim 9, wherein a valve controller in an engine having an engine control module (ECM) executes the method.

15. The method of claim 9, wherein an engine control module (ECM) in an engine having an air intake valve controller executes the method.

16. A system for controlling an intake valve of a vehicle manifold, comprising:
means for receiving a slew rate associated with the valve; and
means for altering a control parameter associated with movement of the valve in response to the means for receiving.

17. The system of claim 16, wherein the control parameter is an output voltage to the valve.

18. The system of claim 16, wherein the control parameter is a valve position sampling period.

19. The system of claim 16, wherein the control parameter is a target valve position input to a control algorithm.

20. The system of claim 16, wherein the means for receiving and means for altering are embodied in an engine control module (ECM) and/or a valve controller electrically connected to the intake valve.
